(19) United States
(12) Patent Application Publication
(10) Pub. No.: US 2025/0068975 A1
(43) Pub. Date: Feb. 27, 2025

(54) AUTOMATED ARTIFICIAL INTELLIGENCE TOPOLOGY GENERATION

(71) Applicant: Fantagic Holdings LLC, Naples, FL (US)

(72) Inventors: James Duane Bennett, Naples, FL (US); Bindu Rama Rao, Naples, FL (US)

(21) Appl. No.: 18/806,798

(22) Filed: Aug. 16, 2024

Related U.S. Application Data
(60) Provisional application No. 63/534,540, filed on Aug. 24, 2023.

(51) Int. Cl. G06N 20/00

(52) U.S. Cl. CPC G06N 20/00

(57) ABSTRACT

Based on user work product and underlying source data information, automatic generation of artificial intelligence (AI) topology defining operations for future AI generations each mimicking the approach and format of the user work product. Hosting services supports user interaction to gather work product examples and source data information, and also supports automatic identification of: (i) frames or elements of user work product; (ii) primary AI and support processing nodes to service content generation for each frame (or element); (iii) cross frame topology influence linkages; (iv) pattern data associated with each frame; and (v) AI and support processing based topologies for each frame. AI and support processing nodes being selected from a plurality of available nodes provided by the hosting service. Insufficient performance of such available nodes drives custom, automatic training of AI nodes and/or creation of support processing nodes with and without auto programming assist. During operations, user interactions trigger regeneration of all or certain frames and may inject temporary or permanent topology changes. User's underlying source data information and process of creating user's work product without AI assist can be monitored with gathered data from monitoring being used in the automatic generation of frame topologies and also used in future AI based generations according to such topologies to deliver generated output in the format of the user's work product and meeting the expectations of the user.

### RELATED APPLICATIONS

The present application incorporates by reference herein in its entirety and for all purposes U.S. Provisional applications: a) Ser. No. 63525817, filed Jul. 10, 2023, entitled “Multi-Node Influence Based Artificial Intelligence Topology” (EFS ID: 48272269; Atty. Docket No. GAO1); b) Ser. No. 63528145, filed Jul. 21, 2023, entitled “Segment Sequencing Artificial Intelligence Topology” (EFS ID: 48330922; Atty. Docket No. GA02); and c) Ser. No. 63529461, filed Jul. 28, 2023, entitled “Artificial Intelligence Store with Builder and Client Side Personalized Trusted Output” (EFS ID: 48365256; Atty. Docket No. GA03).

### BACKGROUND

### 1. Technical Field

The present invention relates generally to generative and discriminative artificial intelligence; and, more particularly, to remote and local artificial intelligence serving a common functional objective.

### 2. Related Art

Basic training and deployment of single nodes of generative and discriminative Artificial Intelligence (hereinafter “AI”) is commonplace. Various AI models currently exist while other models are under development to gain high quality AI output and discrimination. In addition to the model's themselves, the amount of training data utilized continues to grow with quality of training data also becoming more important.

AI models are designed and trained to operate as single node AI elements, for example, taking in user text queries and output anything such as a poem, short story, or summary description. This comprises only a fraction of what each user might like to accomplish in their particular overall goal underlying their desire to use the single node AI service. To have custom designs prepared for a user, high costs and skill levels are required. As is, only the largest of companies are integrating AI solutions using teams of AI experts.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic diagram illustrating an exemplary capture, by an artificial intelligence (herein, “AI”) based auto-topology generating infrastructure, of a user's interactions in gathering input used for the user's service of an overall repeated objective, wherein a generated plurality of topology frames are to be used to service the overall repeated objected with and without user involvement;

FIG. 2 is a functional diagram illustrating one embodiment carried out according to various aspects of the present invention set forth in FIG. 1, wherein a user delivers their previously created sales brochure postings for clothing items along with identifying details regarding source data and source access information used for each of their previously created sales brochure postings from which a series of topology frames are auto-created for future AI based generations of sales brochure postings;

FIGS. 3 and 4 are schematic block diagrams illustrating several exemplary topologies employed for identifying primary Artificial Intelligence (AI) and Support Processing (SP) nodes to serve as the core element in each topology frame, wherein each type of frame input and output data type and underlying purpose being associated with a particular one of the several exemplary topologies illustrated;

FIG. 5 illustrates exemplary automatic and automated training of baseline and untrained Artificial Intelligence (AI) nodes which is employed when available pre-trained AI nodes prove deficient during auto-selection and for use as a primary AI node within an auto-created topology frame, in accordance with various aspects of the present invention;

FIG. 6 is a functional diagram illustrating an exemplary embodiment of part of the auto-topology creation, and, more specifically to one way to carry out automatic identification of cross frame influence to service the brochure posting example of FIG. 2, in accordance with various aspects of the present invention;

FIG. 7 illustrates exemplary topology frames automatically created based on the user's brochure posting example of FIG. 2, wherein a visual workspace on a user's device screen displays each of the automatically generated frame topologies for review or modification by the user should the user have interest;

FIG. 8 is an exemplary schematic and perspective diagram illustrating a hosting platform supporting various services such as automatic topology creations, distribution and use services, wherein traditional, human directed created overall objectives are migrated into frames of AI topology for future overall objective servicing which is carried out across hosting, user and creator systems, in accordance with various aspects of the present invention;

FIG. 9 is an exemplary flow diagram that illustrates a process for generating a plurality of topology frames based on user source data and prior user created output data, wherein the process delivers an auto-generated set of topologies to serve future overall generative goals; and

FIG. 10 is another exemplary flow diagram illustrating deployment of a set of topologies auto-generated pursuant to the flow diagram of FIG. 10, wherein such deployment of the set of topologies delivers future generated output data automatically from input data sources with little if any user intervention needed. an exemplary AI training topology designed in accordance with the present invention wherein a baseline or untrained AI node is trained by a hosting service utilizing both selected groups of training data from pre-prepared training datasets and also uploaded training datasets of a creator with ownership and authorization concerns curated and certified by the hosting service.

### DETAILED DESCRIPTION OF THE DRAWINGS

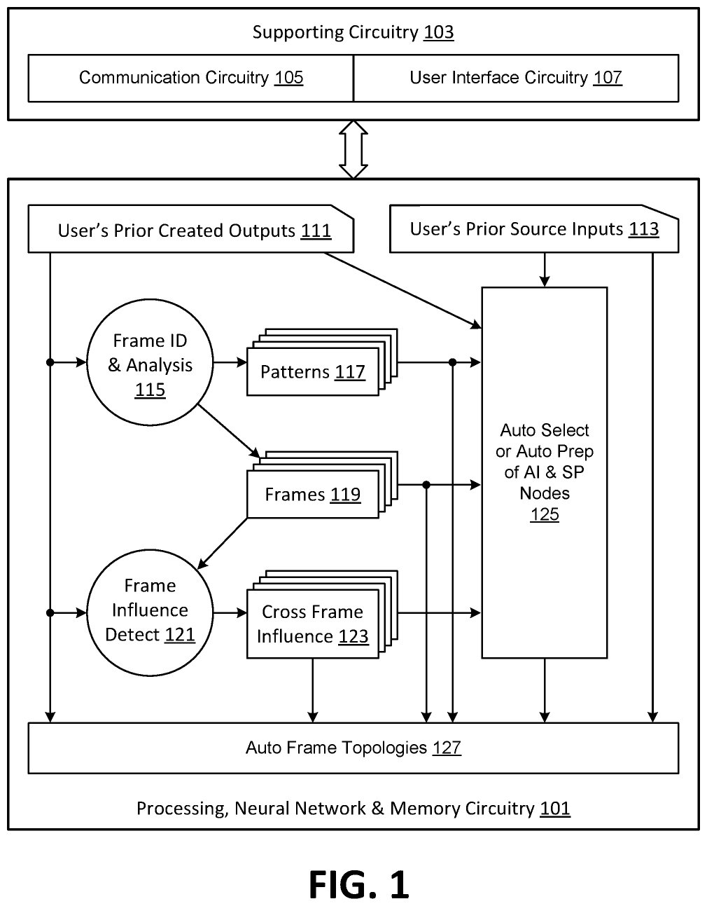

FIG. 1 is a schematic diagram illustrating an exemplary capture, by an artificial intelligence (herein, “AI”) based auto-topology generating infrastructure, of a user's interactions in gathering input used for the user's service of an overall repeated objective, wherein generated topology frames are to be used to service the overall repeated objected with and without user involvement. Therein, a user that has manually (without AI involvement) produced collections of output for a particular overall objective is able to interact to automatically create an AI based topology that will perform the user's manual tasks automatically. To accomplish this, the user delivers their manually produced output (e.g., a brochure, storybook, poetry book, songbook, music, advertisement, technical specification, video, control signals, communication outputs, etc.) along with all the source data from which their outputs were created to a processing, neural network, and memory circuitry 101. Based on such deliveries, the processing, neural network, and memory circuitry 101 creates an overall AI based topology which the user can deploy to carry out their manual task in an automated or automatic manner. Herein, “automated” operations are those which involve one or more user confirmations or other user interactions as part of the overall AI generative process, while “automatic” operations are those where the overall AI generative process is carried out without user intervention beyond what is needed to trigger the generative task.

The processing, neural network and memory circuitry 101 gather's the user's source data inputs that the user utilized to manually create user's prior created outputs 111 via interactions with supporting circuitry 103. Both the supporting circuitry 103 and the processing, neural network and memory circuitry 101, depending on the configuration, can be located fully within, or distributed between, one or many of a plurality of local and remote systems. For example, a user may have created numerous retail sales brochures. Each brochure being a compilation of a plurality of text elements and a plurality of image elements, and wherein the source of these pluralities is based at least in part on contents of a manufacturer's database. The user may then deliver to the processing, neural network and memory circuitry 101 both the user's prior created outputs 111 (here, the user's brochures) and user's prior source inputs 113 (here, the manufacturer's listed data used and requirements such as authentication/authorization to gain access to such listed data). Such deliveries taking place through user interface circuitry 107.

As used herein, “source data” and “source inputs” both refer to the actual data used in generating frame content, while “source data information” includes both source data and details for accessing source data. For example, for a user's work product such as a sales brochure may have been prepared by the user from a source data extracted from a manufacturer's database. Login and path data along with the source data being source data information. In other words, for the sales brochure underlying source data information was used to generate at least portions, i.e., at least some frames, of the brochure.

The user's prior source inputs 113 may be delivered directly, for example, by a user's: a) typing in the pathed location of all source data information used; b) provide authorization and authentication steps needed to gain access for automatic operations or to indicate a need for user assistance in a more automated approach; and c) provide the actual data used to construct the user's prior outputs (e.g., brochures). The user's prior source inputs 113 can alternatively be collected by the processing, neural network and memory circuitry 101 by monitoring a user's interactions with, for example, the user's employment of the user's web browser to locate and log into the manufacturer's database to extract the particular database entries that they used to construct their compilation (e.g., the brochure). Either way, the actual data used and all associated information regarding data source origination is captured and stored as the user's prior source inputs 113.

Once the user completes deliveries of their manually generated compilations (e.g., brochures with various text and image portions comprising the user's prior source inputs 113 and the user's prior created outputs 111), the processing, neural network and memory circuitry 101 generates an overall AI based topology that can carry out the manual and perhaps somewhat automated efforts of the users.

In particular, the processing, neural network and memory circuitry & interface elements 101, based on both the user's prior created outputs 111 and user's prior source inputs 113, identifies frames of underlying component parts of the user's prior created outputs 111 wherein each frame requires at least one particular topology node to service subsequent frame generation. In addition, the processing, neural network and memory circuitry & interface elements 101 defines topologies to carry out the AI generations of all frames and construction of the final combined output.

Although one AI node might service several frames, more often different AI nodes designed for differing purposes are needed to best serve the needs of an underlying frame. For example, some frames require text generation while others require image, voice, video, etc., generation. Each of such frames have their own user' input sources and correspond to generated output of a particular data type fit for a particular purpose.

For most user creations, many frames with correspondingly different generative AI outputs are needed to accomplish an overall creation objective (e.g., such as a brochure), wherein each frame is serviced by an automatically produced topology created by the processing, neural network and memory circuitry & interface elements 101 to carry out that frame's subsequent generations. Regarding a storybook overall objective example, a first frame may require generation of a rhyming paragraph for each page, while a second frame requires generation of a corresponding per page image. A first generative topology is thus needed to define the rhyming paragraph and a second generative topology is needed to define the generation of the corresponding page image. For a singalong electronic storybook, a third frame and third generative topology might be needed to generate a singing voiced output based on the rhyming text on each page. In addition, the singalong electronic storybook may interact with speaker and motion elements embedded within a doll, and a fourth generative topology may generate synchronized dancing and lip moving motion commands to enhance a child's experience.

Each frames (and corresponding generative topology) can therefore service a data type destined for direct user consumption (e.g., text, image, audio, voice, video, haptics, etc.) or may not directly service a user but instead be destined for local or remote systems and their functionality such as, but not limited to, control signaling of robotics, appliances, system management, and so on. Generative AI used within frames (even within single frame objectives) herein is thus not limited to generating human consumable output but also to generate any type of output that any type of system can consume, and which services an overall generative objective.

More specifically, the processing, neural network and memory circuitry & interface elements 101 employing frame identification and analysis 115 identifies within the user's prior created outputs 111 frames of common output elements and stores identified frame data as frames 119. In addition, from each frame, influence patterns (also referred to herein as “pattern data”) are extracted and stored as frame patterns 117. Frame patterns are characteristics that are common across the user's prior created outputs 111 for that frame and are to be repeated across future AI generations of that frame. For example, from a user's prior created outputs 111 that each comprise a user's manually created sales brochures, the frame identification and analysis 115 identifies a title frame, descriptive text frame, and image frame. The location and sizing of these frames along with variation data from brochure to brochure along with underlying needed generative AI data types are stored as frame data within the frames 119. Associated therewith, the frame identification and analysis 115 identifies content details such as font, color palette, image style, brush strokes, highlighting, background features, resolution, etc., for each frame and stores this data as the frame patterns 117. The frame patterns 117 and the frame data from the frames 119 to be used for future automatic and automated AI based brochure generations.

Also, a frame generation may depend on other frame generations as indicated in the user's prior created outputs 111. For example, with the storybook example mentioned above, each rhyming paragraph must correlate well with the generated page image. A mention of a dog in the paragraph needs to influence generation of the page image to include a dog. Alternatively, a generated image of a dog can be used to influence generation of the rhyming paragraph. With either such configuration, influence needs are identified by frame influence detect 121 through frame to frame correlations (e.g., by correlating image frame related text to paragraph frame text), such influence being stored as cross frame influence 123. More specifically, a frame influence detect 121 evaluates how closely each of the frames 119 correlate with other of the frames 119 in the user's prior created outputs 111. Strong correlation indicates that future generations of some frames need be influenced by the output of other frames.

Take for example a configuration with an overall generative objective of creating and playing guitar music for kids in an electronic music book form where each page of the book comprises a sheet music of a different song on each page with that music being played in the background by a guitar. A child paging through the music book can then find sheet music that they are interested in and then start playback of the guitar music in the background. From a terminology standpoint, this music book is a “segmented” series of pages, and, on each page, there are two frames: 1) a sheet music frame; and 2) a guitar playback frame. Prior to attempting AI generation of this overall generative objective, the user may, at times, imagine and write a page of sheet music (i.e., the first sheet music frame of the multi-page or multi-segment objective), and then, using their guitar, plays and records that song (i.e., creates the second audio frame of the multi-segment objective). Other times, the user may imagine and play and record a song (i.e., here the first frame), and then transcribe the song to a page of sheet music (i.e., here the second frame). All of the first and second frame data (i.e., audio and sheet music frames for each page of the music book) are analyzed by the frame influence detect 121 which detects a common correlation between the sheet music and the guitar playing audio, and therefore responds by delivering an indication of the need for such influence for storage within the cross frame influence 123. The frame influence detect 121 also evaluates prior page sheet music with current page sheet music and finds such low correlation that no segment frame to next segment frame influence is needed. Likewise, prior audio frames with current audio frames across page segments are compared, and correlation is so low that no cross segment frame influence is warranted between each page's guitar pieces.

In other segmented generation configurations such as a storybook with an image frame and a paragraph text frame on each page (i.e., on each segment), the frame influence detect 121 identifies sufficient correlation within user's prior created outputs 111 both between frames with a segment and between frames across segments. That is, each page (i.e., segment) of the user's manually created storybooks contain a paragraph frame which highly correlates to that page's image frame (hereinafter “inner segment influence”), and the paragraph and image frames of a current page highly correlates with the corresponding prior page's paragraph and image frames (hereinafter “inter segment influence”). Both inter and inner segment influence is stored as cross frame influence 123.

The processing, neural network and memory circuitry 101 base on the frame patterns 117, frames 119, and cross frame influence 123 prepares a set of frame topologies to service, for example, a brochure generation and stores such frame topologies as auto frame topologies 127. The processing, neural network and memory circuitry 101 also evaluates the user's prior source inputs 113 and, based thereon, identifies when to trigger a future generation and identifies how and where to extract needed source input for future generations. Then, once triggered, the processing, neural network and memory circuitry 101 carries out the functionality defined by the auto frame topologies 127 to generate brochures that follow the style and approach of the user in the user's prior brochure creations.

Pluralities of program code, communication, control signaling, images, video, audio, text, music and many other data type elements, herein represented by frames, may be used to service a particular overall work product of a user. Such elements may be combined into a single unit or be distributed across many units. For example, an image frame and a paragraph frame on each page of an electronic storybook. Such storybook may comprise a user's complete work product, but it may also only comprise a portion thereof. For example, the user's work product may also include a communication related frame wherein the electronic storybook is translated into another language and posted on a website for distribution. The work product may also include generating a sing along song based on the paragraph text for delivery to a child's robotic doll that will mimic such singing. Before turning to AI based generation, all of these elements (herein referred to as frames) serving an overall user's purposes or goals, were conducted by a user in stepwise fashion and often manually such as by a) creating and typing in the text paragraphs, drawing the images, b) recording their singing voice, c) posting to a website, and d) delivering the singing audio to the doll for playback. All of these efforts and productions comprising the user's work product for this overall objective.

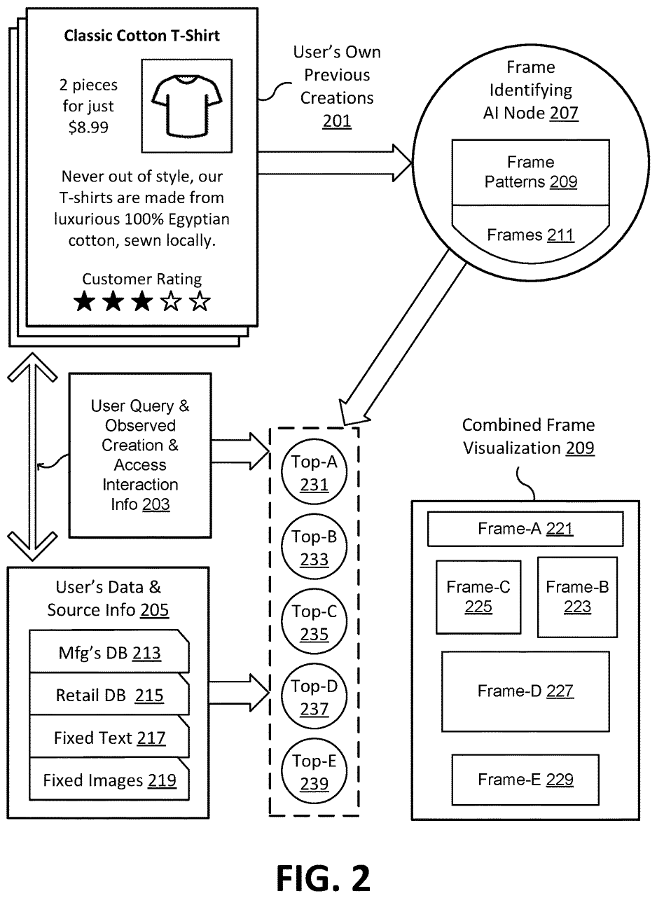

FIG. 2 is a functional diagram illustrating one embodiment carried out according to various aspects of the present invention set forth in FIG. 1, wherein a user delivers their previously created sales brochure postings for clothing items along with identifying details regarding source data and source access information used for each of their previously created sales brochure postings from which a series of topology frames are auto-created for future AI based generations of sales brochure postings. Herein, a user seeking to automate creation of sales brochures submits a plurality of their own creations, user's own previous creations 201, to a frame identifying AI node 207. The frame identifying AI node 207 analyzes the user's own previous creations 201 and identifies in this illustrative embodiment five frames: 1) frame-A 221, a text title portion; 2) frame-B 223, a product image portion; 3) frame-C 225, cost related text; 4) frame-D 227, product description text; and 5) frame-E 229, customer rating information as indicated within a combined frame visualization 209. Each of the five frames will be the basis for an automatically defined five separate topologies, i.e., topology-A 231, topology-B 233, topology-C 235, topology-D 237 and topology-E 239, which will be used to automatically generate future sales brochures for the user.

In particular, when the user created the plurality of the user's own previous creations 201, i.e., the user's previously created brochures, the user based the effort on source data, i.e., user's data and source information 205. For example, the user may have interacted with a manufacturer's database 213 to retrieve the product image and retail price data. The user may have interacted with their own database such as a retail database 215 to gather their own sales mark-down information for the product. Fixed text 217 might correspond to things like their company's guarantee text that might be included in a frame (not shown). Fixed images 219 might correspond to one of six images in memory storage which contain the frame-E 229 image that includes both the “customer rating” text and the five stars with various darkened star ratings. For example, each of the six images correspond to from no darkened stars to all five darkened stars, and based on the retail database rating number, one of the six fixed images 219 are appropriately chosen for the sales brochure.

The user's data and source information 205 is therefore identified for each of the plurality of frames 211. This is accomplished either by the user, interacting with a framed element such as the title frame, the frame-A 221, to enter therewithin the source of the title text for a given brochure. This can be by typing in the path to the base text, indicating access authorization/authentication needs, and identifying the database interface that for example the manufacturer provides to their database 213. Instead of this direct entry approach, a user may alternatively enter a monitoring mode where they visit the data source and extract the source information along with all login steps and access along the way being recorded by underlying processing circuitry and associated support software. Either way, the resultant interaction information 203 needed to gather source data for each frame is captured for use in future generative brochure use.

The frame identifying AI node 207 not only identifies the frames 211 (which defines frame sizing and location on a page along with needed generation data type such as text, image, etc.), but it also identifies frame patterns 209. Each of the frame patterns 209 correspond to a single frame and may include, but is not limited to for example, font sizing, color, bold, italics, font and so on to assist in appropriate text generation, while for images generation, it might include background color, product framing, lighting, contrast, product orientation information, and so on.

Although the exemplary embodiment illustrated involves the processing needs for automatically generating an overall AI based topology that will generate future brochures in an automatic or automated manner, any other type of user creations are supported wherein various types of frame data is utilized to accomplish other overall generative objectives in accordance with the present invention.

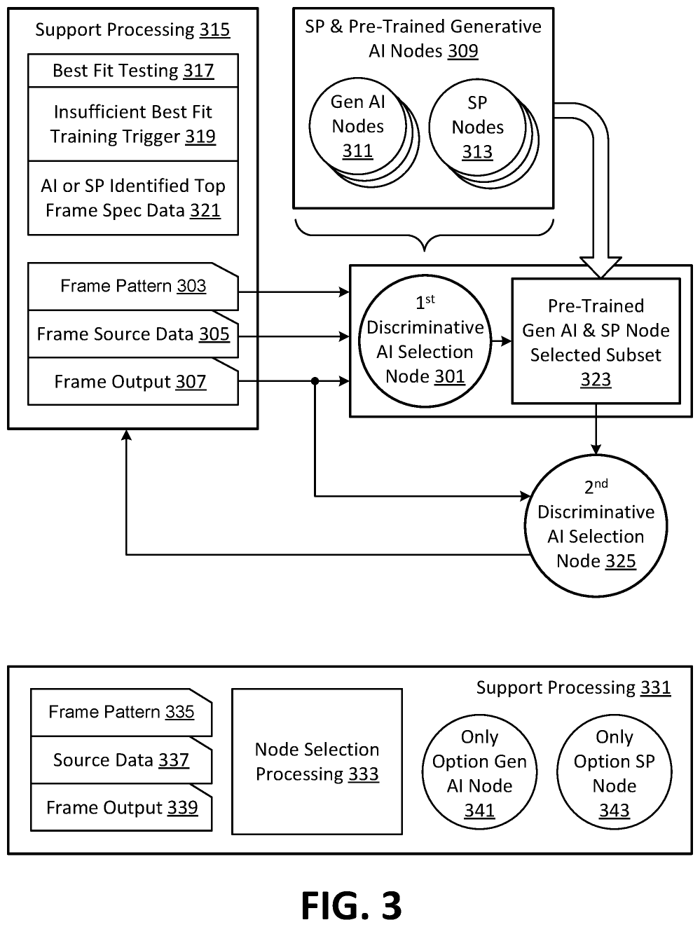

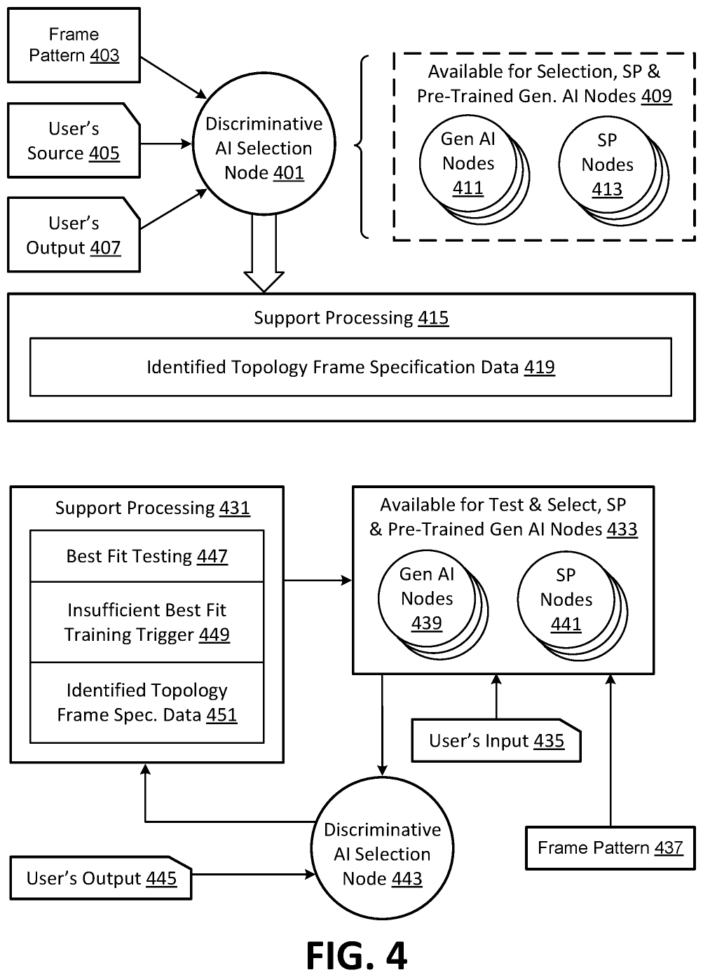

FIGS. 3 and 4 are schematic block diagrams illustrating several exemplary topologies employed for identifying primary Artificial Intelligence (AI) and Support Processing (SP) nodes to serve as the core element in each topology frame, wherein each type of frame input and output data type and underlying purpose being associated with a particular one of the several exemplary topologies illustrated. In FIG. 3, support processing 315 evaluates the characteristics associated with a frame to identify underlying frame population needs and, based thereon, selects from generative AI nodes 311 and support processing nodes 313 in an attempt to best meet those needs. For example, if an identified frame is merely populated from a user's data source without any additional processing but perhaps minor formatting changes, one of the support processing nodes 313 could be selected. If instead, a frame requires a more complex population, AI generation may be warranted and one of the generative AI nodes 311 could be selected.

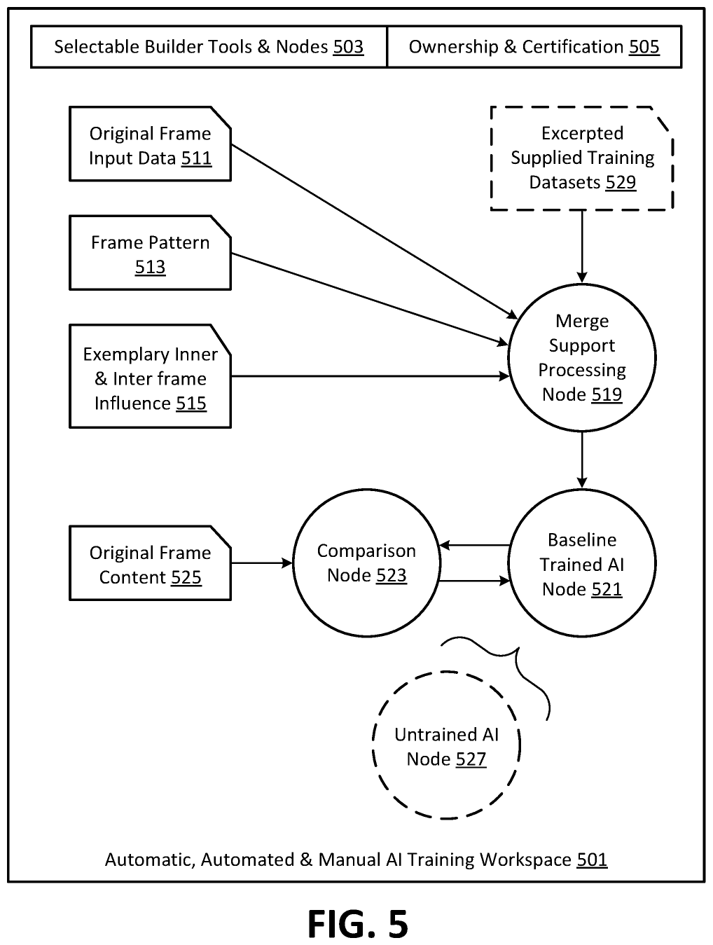

To make these determinations, the support processing 315 enlists the help of a first discriminative AI selection node 301 that considers the frame pattern 303, frame source data 305 and frame output 307. From this, the first discriminative AI selection node 301 might for example receive source data as text and frame pattern data as text and the output might an image. In this situation, the first discriminative AI selection node 301 reduces the overall list of generative AI nodes 311 to a subset where text is input and images are output, and further where there are two types of inputs with one being user provided source data and the other being pattern influence data. A variety of other factors might also be involved including cost, trust and security or other factors important to the user. Assuming a subset is identified from the generative AI nodes 311, that subset is tested to determine which of the subset performs best. This is carried out according to best fit testing 317 processing code portion of the support processing 315. Each of the selected subset of the generative AI nodes 311 receives the frame pattern 303 and frame source data 305 to influence node generation. Each generated output is compared by second discriminative AI selection node 325 and the best overall generative AI node of the selected subset of the generative AI nodes 311, i.e., the best of the selected subset 323, is identified to be used as a core element of the topology for that frame so long as the comparison (correlation factor) is above a certain threshold of acceptability. If it fails to meet the acceptable threshold, an insufficient best fit results may deliver a training trigger 319 wherein a baseline trained AI node is fine tune trained or a fully untrained AI node is trained, both as described with reference to FIG. 5.

To service some frames, the first discriminative AI selection node 301 may alternatively select a node subset from the support processing (SP) nodes 313 which seem to be able to meet the frame population requirements. Each of such subset of SP nodes then deliver output based on the frame pattern 303 and the frame source data 305. Each such output delivered is then compared by the second discriminative AI selection node 325 to evaluate how well the delivered output correlates with the user's frame output 307 (i.e., the user's created output for a given frame). A correlation comparison may then identify the best SP (support processing) node of the SP nodes 313 to be used for subsequent frame content production. If the best fitting SP node fails to reach a sufficient threshold, either a reattempt using other of the support processing nodes 313 and the generative AI nodes 311 may be attempted. If those attempts fail, a user may be assisted in automated creation of a tailored version of the support processing code generation that will adequately meet the frame needs. Any best fit and acceptable node identified will be stored for use in a topology tailored for that particular frame within the topology frame specification data 321.

Moreover, some SP nodes and generative AI nodes may together be selected and tested to find a best fit whenever both seem viable options to the first discriminative AI selection node 301. Otherwise, the testing continues node by node with the best fitting node of either generative AI or support processing being identified as the best fit for the present frame.

The approach used to identify a best fit node, either AI or support processing based variety, depends in large part on the type of data input and type of data output. The approach detailed above regarding the support processing 315 and both the first and second discriminative AI selection node 301 and 325 is used when the first discriminative AI selection node 301 is not capable of making a definitive identification, such as perhaps when attempting to identify image output that will best meet the needs of a discriminating user. But for other types of output and where a discriminating AI can appropriately identify a best fitting node, the process can be easier. And with some types of user's source data input to acceptable output requirements, the process may be so basic that even a discriminative AI node is unnecessary. In yet other types of input output flows, there may not be any more than a single option, and picking and choosing becomes unnecessary.

For example, within support processing 331, to service a certain frame, node selection processing may only evaluate frame pattern 335, user's frame source data 337 and user created frame output and decide between the only two options available, a single AI node 341 and a single support processing (SP) node 343.

FIG. 4 illustrates a few of many other possible approaches to identifying a particular generative AI node or support processing node to service a particular frame. Specifically, for certain types of input data types and output data types, only one discriminative node, one discriminative AI selection node 401, is used to evaluate frame pattern 403, user's source data 405, and user's output 407 related to a given frame and, based thereon, pick from those generative AI nodes 411 and support processing nodes 413 of available nodes 409. In this case, the discriminative AI selection node 401 being so accurate considering this specific type of frame that testing is unnecessary. Whether a support processing node or a generative AI node is selected to service that particular frame, such selected node's identity is stored as topology frame specification data 419.

Likewise, when there is no value in attempting to try to select from a group of seemingly viable node options, there is no need for a first discriminative AI selection node to create subsets. In such circumstances all available possibilities can be tested without subset selection. In particular, for certain types of input and output data, support processing 431 directs a discriminative AI selection node 443 to compare output of all support processing and all generative AI nodes 433 based on a user's input source data 435 and frame pattern 437 data, i.e., best fit testing 447. Each output of the nodes 433 are compared to the user's created output for that frame, i.e., user's output 445, by the discriminative AI selection node 443 which outputs a correlation indication for each comparison. If the correlation indication for a best fitting node of the nodes 433 meets a minimum performance threshold, it is identified in topology frame specification data 451 to service the current frame. If the threshold is not met, either full or fine tune training of an AI node that will suit the current frame needs is pursued as set forth with reference to FIG. 5 (as indicated by training trigger 449) or assisted programming (or program modification) is deployed to create an appropriate support processing node tuned to best serve the current frame.

FIG. 5 illustrates exemplary automatic and automated training of baseline and untrained Artificial Intelligence (AI) nodes which is employed when available pre-trained AI nodes prove deficient during auto-selection and for use as a primary AI node within an auto-created topology frame, in accordance with various aspects of the present invention. As described in relation to FIGS. 3 and 4, if pre-trained AI nodes are not sufficient to service a given frame, automated training is launched to create an AI node that can provide such service. The hosting service that provides the training interface offers automatic, automated and manual AI training associated with a workspace 501 through which a user may choose to interact. Herein, original frame input data 511, frame pattern 513, and exemplary inner & inter frame influence 515 (if any) are merged and, along with any excerpted or supplied training datasets 529, are delivered either to a previously baseline trained AI node 521 for fine tune training or to an untrained AI node 527 for full training. Training also involves comparing in a correlative manner (by an AI node 523) the output of the AI node 521 or 527 with the original frame content 525 created by the user. The correlation indicates how well the AI node under training performs and, more importantly, is used in feedback path training of the AI node to achieve better performance. Herein, training sets, cycling, sequencing and overall training configuration is automatically carried out for the user. Even so, the user may interact to enhance or modify the training using a variety of tools and training topology nodes 503 along with interacting to verify underlying data ownership rights, identify digital rights management procedures, and to gain certification 505.

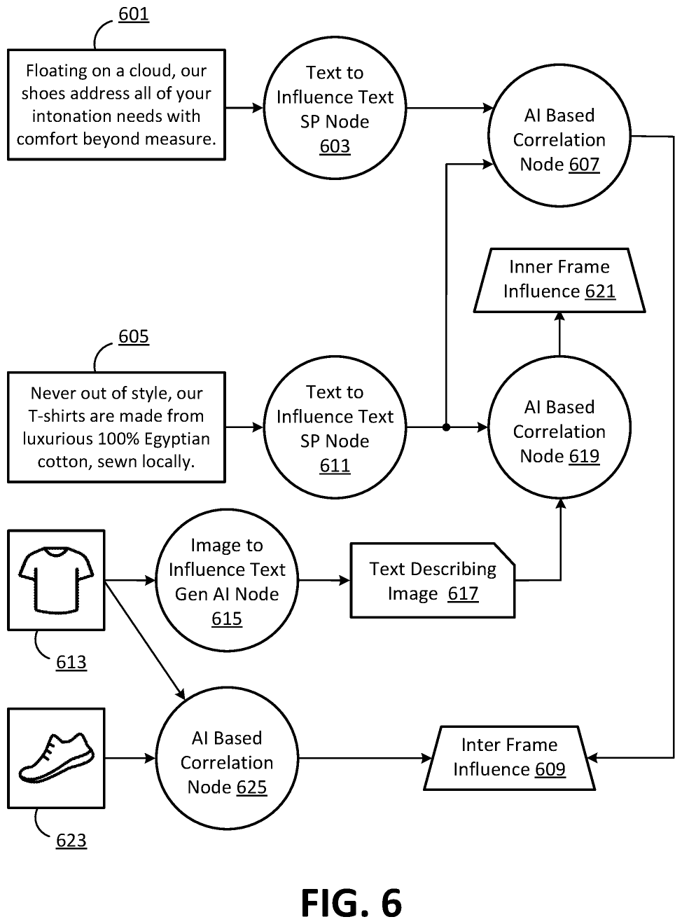

FIG. 6 is a functional diagram illustrating an exemplary embodiment of part of the auto-topology creation, and, more specifically to one way to carry out automatic identification of cross frame influence to service the brochure posting example of FIG. 2, in accordance with various aspects of the present invention. As previously mentioned, frames correspond to independent elements of an overall objective which in this example is a user's sales brochure. One step in the automated creation of an overall generative AI based topology involves an analysis of a user's own prior creations on a frame by frame basis to try to identify commonality or correlation between frames. Correlations between any two frames within a single segment such as a single brochure is referred to herein as inner frame influence and a need for such influence is stored within inner frame influence 621. Correlations between two frames of two segments, here between two brochures is referred to herein as inter frame influence and a need for such influence is stored within inter frame influence 609. Both inter frame influence 609 and inner frame influence 621 help define the topology that will be automatically constructed to service that frame in AI based generations of brochures that the user may find acceptable.

For example, to assist in the automated topology creation for a frame, that frame is configured to be serviced by AI generation that takes into account correlation requirements that the user has applied in prior self-created output such as prior user's brochures. If a descriptive text in a frame in one brochure exhibits a strong correlation with descriptive text in another brochure, a topology must include an influence linkage between these frames in future AI generations of new products' descriptive text. If this is the case and the linkage is needed, an indication of this need is stored in the inter frame influence 609.

To identify the need for influence linkage between two frames within a single brochure (herein referred to as a single segment), the content from the two frames is prepared for comparison. If one of the frame's content is of a different data type, a generative AI node will translate one data type to another as part of the process. Then with like data type inputs, another AI will determine the degree to which the two frame's content exhibit correlation. If correlation exists above a threshold, the two frames will be linked in a resulting generative topology to carry forward inner frame influence. Similarly, if within two of the user's created brochures, a certain frame holds content in a first brochure that highly correlates that frame's content in a second brochure, then those frames will also be linked in the resulting generative topology to carry forward inter frame influence.

For example, to identify whether there is inter frame influence 609, a common frame's content across two of the user's created brochures are compared to generate a correlation level indicator. As illustrated, within a first of the user's prior, self-created brochures, a common frame across all brochures contains first descriptive text 601 relating to a first product being advertised. Likewise, within the same common frame within a second of the user's prior, self-created brochures, second descriptive text 605 can be found which relates to a second product being advertised. The first and second descriptive texts 601 and 605 are both correspondingly pre-processed by support processing nodes 603 and 611 to produce two outputs formatted for use as inputs into an AI based correlation node 607. Various types of pre-processing performed by the support processing nodes 603 and 607 is contemplated, including but not limited to, stemming or lemmatization, lower casing, stop word removal, feature extraction, vectorization, and so on. The AI based correlation node 607 responds to the two inputs by generating a correlation level indication between the two that indicates, if correlation is high, that future content generations for use in the present common frame needs to take into consideration prior generations of such common frame. This indication is stored within the inter frame influence 609. Yet here in the present example, the AI based correlation node 607 fails to find sufficient correlation to justify inter frame influence 609.

Evaluation of needs for inner and inter frame influence applies to all types of data beyond mere text as well. For example, regarding inter frame influence, a first product image 623 from a common image frame of a first of the user's created brochures is compared to a second product image 613 with the common frame of a second of the user's created brochures. These two images are compared by an AI based correlation node 625 which delivers a correlation indication that, if above a certain correlation threshold, indicates a need to link future AI generations of the present frame with prior frame image content as indicating in the inter frame influence 609. But as before, in the present configuration, the correlation threshold is not met, and with no need for future AI generations to be influenced by inter frame topology linkages.

For inner frame influence need determinations, evaluating correlation between two frames of a single segment (i.e., here within a single brochure) is performed. Such two frames may involve the same data types or differing data types such as that illustrated. Here, the second product image 613 is compared to the second descriptive text 605 both of the second of the user's own created sales brochure for a T-shirt product the user offer's for sale. An image to text generating AI node 615 assists by extracting from the second product image 613 text information that describes the product featured within the second product image 613, i.e., descriptive text 617 relating to the T-shirt product within the second product image 613. The descriptive text 617 is then compared for correlation with the pre-processed text based on the second descriptive text 605 by an AI based correlation node 619. If high correlation is found, as is the case in this example, an indication of a need for inner frame linkage between these two frames is stored within the inner frame influence 621.

Of course, there are many other types of frame data content that may be compared to others of differing frame data content across one or even multiple segments. For example, in multi-segment generations such as where a single segment comprises a series of segment generations each corresponding to a single page of a storybook, inter frame influence may not only require influence linkage back to a prior page's generation, but also to all or a subset of prior page generations in order to maintain tight coupling of generation context. Data types to be correlated is not limited to human consumable frame content such as audio, video, image, text, haptics, etc. Instead, data type frame content may be program code or control signals for manipulating local or remote user devices and software running thereon. Correlations between frames of such data types may also be conducted. To do so, either correlating AI nodes must be trained to make such comparisons of one data type against a second data type, or an assisting translating AI node can be deployed which will translate one data type into a representative data type such that common data types can be compared for correlation such as that shown by the translation of an image data type to representative text by the AI node 615.

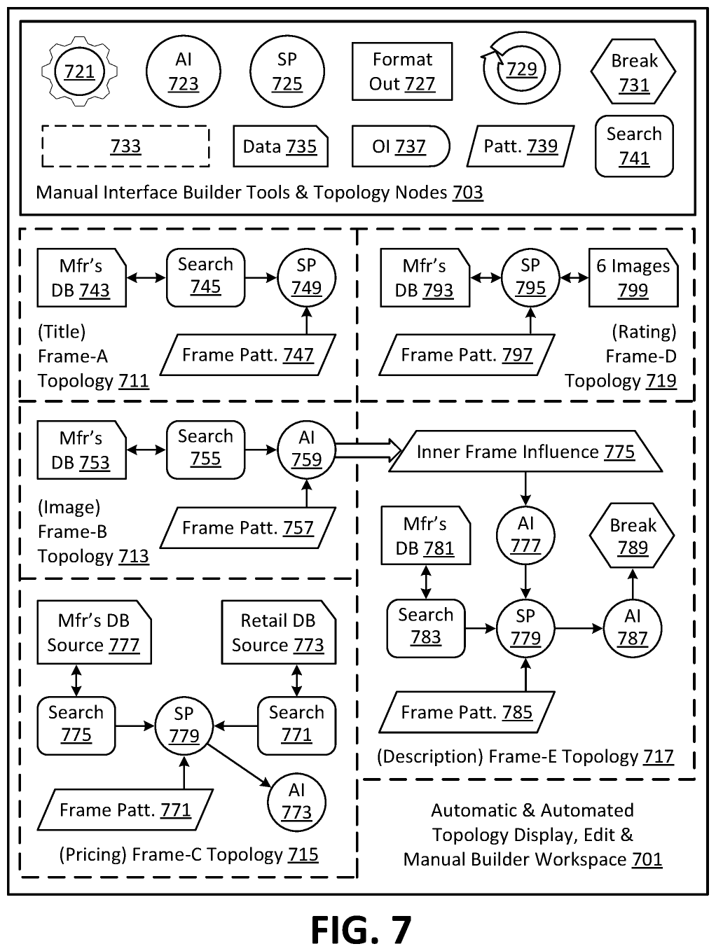

FIG. 7 illustrates exemplary topology frames automatically created based on the user's brochure posting example of FIG. 2, wherein a visual workspace on a user's device screen displays each of the automatically generated frame topologies for review or modification by the user should the user have interest. In particular, the illustrated topologies associated with each frame are automatically generated using: a) the available generative AI and support processing nodes selected to service each frame as described with reference to FIGS. 3 and 4; b) any trained AI nodes needed as described in reference to FIG. 5; c) any new support processing nodes created when available support processing nodes prove insufficient as described with reference to FIGS. 3 and 4; d) the frame patterns and frame definitions identified with reference to FIGS. 2; and 3) any inter and inner frame influence linkages needed as identified with reference to FIG. 6.

In other words, beyond user interaction in the outset to capture a user's prior creations along with source data information, the entire process of generating an overall AI based topology for generating output like that which the user has previously created occurs automatically. Frame identifications, frame patterns, cross frame influence (i.e., inner and inter frame influence), AI and support processing nodes needed for each frame, and so on are all identified automatically and then used in concert on a frame by frame basis to produce a frame topology again automatically that is capable of generating future frame content.

In particular, as shown by a hosting service, automatically generated topologies are illustrated which together generate for a user sales brochures instead of requiring that the user manage such brochure creation manually. The automatically generated topologies can then be edited if needed using a variety of builder tools and topology nodes 703. The generated topologies in the sales brochure example are: 1) a frame-A topology 711 that produces title text; 2) a frame-B topology 713 that generates product images; 3) a frame-C topology 715 that generates pricing information; 4) a frame-D topology 717 that generates product description text; and 5) a frame-E topology 719 that delivers product rating data. Together, when a brochure generation is triggered, these topologies activate to produce their frame content which is then constructed into a form of a single, newly generated brochure.

Specifically, within a first of the automatically generated topologies, the frame-A topology 711 utilizes a search node 745 which access and retrieves from a manufacturer's database 743 text from a database field that is easily processed by support processing node 749 according to a frame pattern 747 (for example, calling out font, font size, bold, black color) to fit within a title frame, the frame-A. A frame-B topology 713 similarly extracts using a search node 755 from the manufacturer's database (here referred to for reference as a manufacturer's database 753) a product image. Because the product image extracted may not have the desired background, format, resolution, contrast and so on, an AI node 759 receives the manufacturer's product image and generates based on the frame pattern 757 (defining such format, resolution and so on) an output sized for a product image frame, the frame-B.

Similarly, a frame-C topology 715 generates pricing related text to fit into frame-C. To do this, suggest retail pricing data is extracted from the manufacturer's database (here referred to for reference as manufacturer's database 777) by a search node 775, while a discount percentage for the product is extract from a retail database 773 by a search node 771. A support processing node prepares an output for deliver as input to an AI node 773 which will produce the pricing text for frame-C. The support processing node accomplishes this by merging and pre-processing the suggest retail pricing data, the discount percentage data, and frame pattern 771 data (such as defining font size, font, coloration, strike-outs, and so on) into a single output that is delivered to the AI node 773. Based on the delivery, the AI node 773 generates the pricing text for frame-C.

Similarly, for the frame-D topology 719, manufacturer's database 793 is accessed by support processing 795 to extract a customer rating number associated with the product. The support processing 795 uses the customer rating number along with frame pattern 797 to choose and place one of six images 799 that corresponds to such rating number, e.g., a highest customer rating number drives a selection of the one of the six images 799 that contains a five darkened star output signifying a five star rating. The selected one of the six images 799 in accordance with the frame pattern 797 is delivered as frame-D content.

As defined by the frame-E topology 717, the manufacturer's database (here referred to as manufacturer's database 781 for reference) is again accessed to extract text that might be used to help influence generation of descriptive text by AI node 787. Along with such extracted text, inner frame influence 775 from the image generating frame, i.e., from the frame-B topology 713 in the form of inner frame influence 775. That is, inner frame influence 775 comprises the product image generated by the frame-B topology 713 which needs to be described in the generated text by the frame-E topology 717. To accomplish this, after its generation for frame-B, the product image (i.e., the inner frame influence 775) is delivered to an AI node 777 which receives images and generates descriptive text therefrom as an output. Such descriptive text output along with the frame pattern 785 and the text extracted via search node 783 are preprocessed and merged into a single input into an AI node 787 which generates the descriptive text. All the topology content generated across all of the topologies 711, 713, 715, 717 and 719 are fitted per frame definition into a visual brochure output for user perusal, approval, rejection or requests for reattempts during a break 789. If acceptable, the brochure can be outputted into a final format desired by the user. Otherwise, reattempts can be made of all frames or only those frames which the user may not like. A user's input can be directed to a particular frame by interacting with such frame directly on the presented visual brochure output, and inputting critiquing data or merely requesting a reattempt. If with a critique, such input data is then added as influence data by way of one or more new nodes, e.g., a new data node 735, being placed within the topology. For reruns without commentary, cycling until a user finds an output acceptable occurs with the same topologies previously defined. In addition, if comfortable with the builder tools and topology nodes 703, the user may directly modify any or all of the topologies indicated including configuring or reconfiguring each node of the topologies illustrated via direct interaction which such nodes.

Also, although the entire process can be fully automatic from triggering a desire for a new brochure to receiving a full brochure example that may be accepted or modified by the user, the entire process may instead flow in a more automated, step by step manner wherein the user may confirm each frame, frame pattern, cross frame influence, source data interaction, topology identification and topology node selection and configuration, for example. This automated flow may be extended beyond the creation of the overall topologies needed to service an overall generative objective such as to create a brochure as well. Automated flow can replace fully automatic generation in a frame by frame approach such as where the user evaluates each frame's generated content and approves (or invokes a rerun) on a frame by frame basis until the last frame's content is user approved and the final generated brochure is delivered.

The builder tools and topology nodes 903 contain various icons that may be dragged and dropped onto a screen workspace on a user device display. The user may change the automatically generated topologies by adding, replacing or modifying any node or configuration associated therewith. Such icons include an AI node 723, support processing node 725, data node 735, outside influence node 737, search node 741, frame pattern 739, output presentation formatting node 727, break node 731 and segment delay 729. In addition, setup tools 721 can be accessed and frame dividing box 733 can be placed to contain a frame's topology for each frame topology as shown.

Once dropped on the workspace 701, user's interaction with an icon such as a right click mouse for example, allows for node type and configuration selections to tailor a select a node icon for a particular purpose. Hosted, client device or other remote system may be identified as to the location such node interaction and functionality will take place. The data node 735 and any other node added can be configured through user interaction after dropping them into a topology. For example, through interaction, the data node 735 can be configured to point to the source of the underlying data along with any associated procedures and authentication/authorization data that may be needed. Similarly, the search node 741 is also configurable on interaction to, for example, gather only certain portions of data related to a user input along with any other preconfigured factors. In addition to preprogrammed search configurations, a user may upload their own approach via a software program code upload or creation within a separate window with manual entry by the user or with generative AI coding assistance. Such interactions are not necessary for any of the nodes illustrated within the topologies 711, 713, 715, 717 and 719, as those are automatically configured. They can be modified however via such interaction with each node.

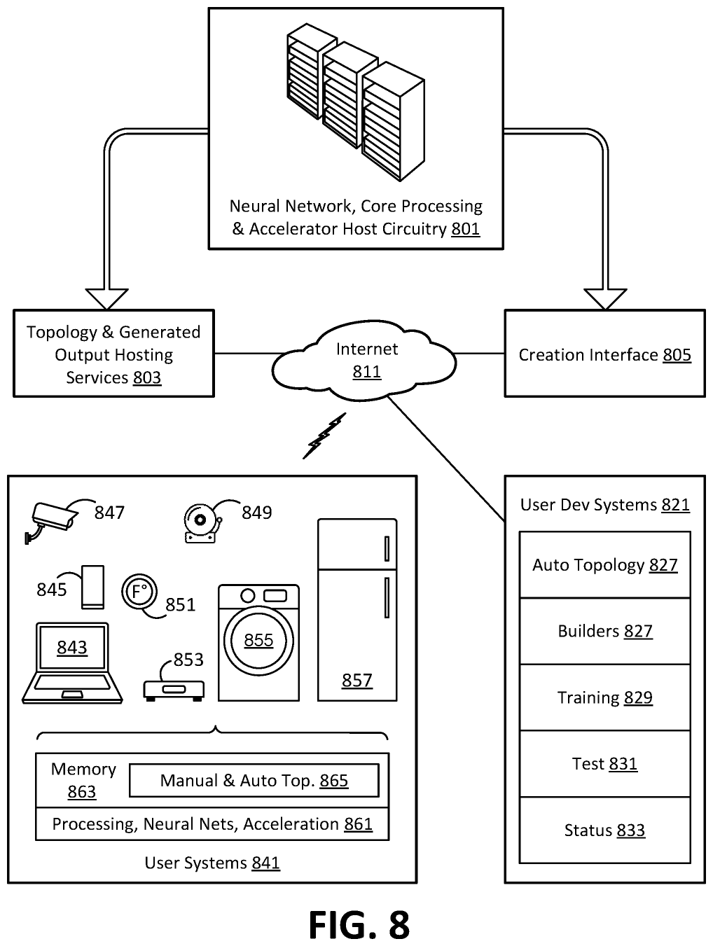

FIG. 8 is an exemplary schematic and perspective diagram illustrating a hosting platform supporting various services such as automatic topology creations, distribution and use services, wherein traditional, human directed created overall objectives are migrated into frames of AI topology for future overall objective servicing which is carried out across hosting, user and creator systems, in accordance with various aspects of the present invention.

FIG. 8 is a schematic and pictorial diagram illustrating exemplary systems and circuitry of a trusted AI (artificial intelligence) topology service that offers automated and automatic topology construction and hosting in accordance with various aspects of the present invention. Host circuitry 801, provides, with DRM (digital rights management) support and searchable and browsable based selection interfacing, a hosting infrastructure that provides: 1) a generated content hosting service for distributing posted AI generated output; 2) a topology builder hosting service supporting creation of entire AI based topologies created automatically and manually as described above; 3) a topology hosting service wherein created AI topologies can be offered to all or select users; and 4) a node modification and creation hosting service wherein any type of the hosts supplied topology nodes may be cloned, modified, trained or created entirely from scratch via either a provided visual interface or via uploads or interactions associated with a software development kit (SDK).

For all hosting services, rating and commentary support interfaces are provided. Guaranteeing owners, creators and users (or herein “clients”) an overall safe and trusted environment free from AI supported fraud and other malfeasance, the host circuitry 801 and supporting hosting services are designed employ data flow security, private data compartmentalization, and employ digital rights management (DRM) practices along with adequate watermarking and distribution controls with host curation and validation of overall generative AI objectives. Further efforts are made to limit third party hidden malware introduction by monitoring, evaluating and controlling third party topology nodes introductions to detect malware attempts and to identify and prevent associated DRM issues. Curation being key on a node by node and overall topology basis to establish a hosting environment that can be trusted by users, owners, and independent creators.

To carry this out, the host circuitry contains neural network, core processing and accelerator circuitry for all topology operations to be carried out by the host. A creation interface 805 via Internet 811 provides user development systems 821 interfaces needed to carry out the overall creation functionality described above including auto-topology generation functionality 827, manual builders 827, AI node training 829, testing functionality 831 and status functionality 833. A host's predefined malware free set of support processing nodes, curated and tested generative AI nodes, and all other types of nodes that may be deployed automatically or manually into AI based topologies are provided.

The host limits access to user information but provides a secure and anonymous pathway for reaching particular users for related advertising and rating commentary, and compensating original source data owners for their participation with automatic and manually created topology generations. Underlying DRM functionality also involves, for example, providing an overall hosting framework in which collection and checking of ownership, authorization, usage rights and related payment collections and shared distributions at every step of node configuration, training and topology generation. At each step and for all creative contributions, rights are admixed with derivative rights included. This process and related curatorship provides a significant value proposition for all involved.

The host circuitry 801 consists cloud infrastructure including racks of neural network circuit elements, core processing elements and accelerators to assist in all of the host processing needs to carry out all of the functionality described herein. Such functionality including but not limited to hosting services 803 and the creation interface 805. For the hosting services 803, some users may create manually or automatically an overall frame set of topologies that they would like to share with others. This can be hosted by the hosting services 803 and may be made available in return for payments received by the host circuitry 801 for distribution to the user and the owners of the underlying source data in a sharing arrangement agreed upon in advance. Other users may want to offer up the generated output of a topology but not want to share the topology itself. The host circuitry 801 also provides such hosting via the hosting services 803.

Automatically generated and manually created topologies may also run in whole or in part across multiple user devices, third party systems, and on host circuitry 801. As mentioned previously, user systems 841 involved in topology interactions may include typical user devices like cell phones 845 and laptops 843, but may also include for example security cameras 847, alarm systems 849, thermostats 851, robot vacuums 853, and appliances 855 and 857 just to name a few. In the user systems 841, memory 863 stores at least portions of the manually and automatically created topologies 865 relevant to the particular device involved of the user systems 841.

For example, a user may have manually created numerous messages about UFO (unidentified flying objects) news for circulation to the user's friends. The process may involve searching a news website for mention of the term UFO and based on search result, the user constructs a summary text output that the user reads out loud and records an audio clip. For one friend, he sends his text summary to a cloud based audio system for translation to audio and delivery thereafter to his friend's cloud based local speaker system. To another friend, he directs the audio to a friend's phone for morning playback at a fixed time with his friend's confirmation of playback. He also sends the audio and original text for storage on the user's laptop 843. All of this being handled originally in a manual manner.

The user then decides to automatically create a generative topology to do this task. To accomplish this, the user interacts with the creation interface 805 with a user development system 821 which may simply be a personal computer. Through the creation interface, the user delivers the outputs and routing information along with command instructions for interacting with the cloud based audio system, with his other the friend's phone, and with his storage on his personal computer 843. The user delivers the outputs and the source inputs as described herein either through monitoring or through interaction with the output frames.

Just as before, frames are identified along with frame content. Some frames being related to the text and audio, and other frames being related to the routing data and associated access information. The search, routing, and access information frames are for human consumption yet are still identified as frames that needs to be generated to carry out an overall AI generative objective. Whether for human consumption or not, from these inputs, an overall AI based topology consisting of a set of frame topologies are generated. Thereafter, each day, the overall topology is triggered and the UFO information is shared.

In a further example, based on motion detection associated with the security cameras 847, a user engages in a manual process that begins with the user failing to identify the user's friends or family members outside of the user's home during the night. The user then interacts with a software application on the user's phone to trigger the alarm 849 to ring. Then, the user attempts to wake up all sleeping family members by calling them one after another on their phones or by yelling their names. Next, the user calls the police to report the trespass and possible home invasion. This takes too much time so the user decides to interact via the creation interface 805 to automatically generate a set of frame topologies to handle this overall AI based objective.

A first frame topology responds to video feed data to identify unknown persons that enter a field of view of the security cameras 847 during nighttime hours. A second frame responds to the first frame's identification by directing each household member's cell phone to broadcast an alert message. A third frame also responds to the first frame by calling the police and reporting the trespass including identifying the user's home address. A fourth frame again responds to the first frame by sending program command instructions to the vacuum robot 853 to place it in a patrol mode which travels room to room to seek and capture video of a break in. A fifth frame also responds by delivering control signals to turn on all lighting around and within the home. Each of these frames are identified and all underlying command and communication data generated along with associated access information is gathered either manually from the user or via monitoring the user's interactions. Based on such gathered information, a full set of frame topologies involving support processing and AI nodes is automatically generated for use thereafter without needing user involvement.

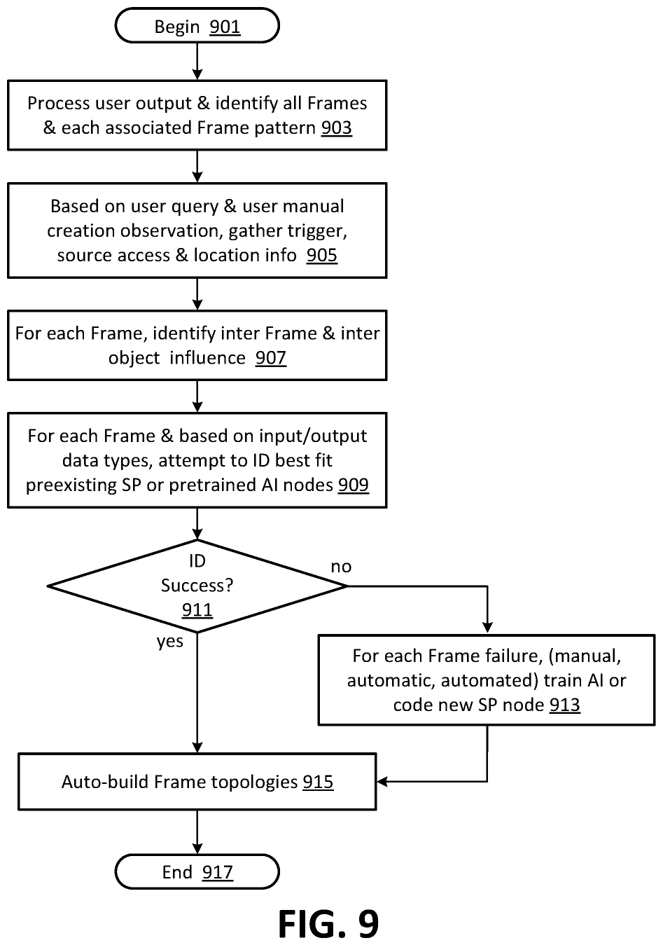

FIG. 9 is an exemplary flow diagram that illustrates a process for generating a plurality of topology frames based on user source data and prior user created output data, wherein the process delivers an auto-generated set of topologies to serve future overall generative goals. Beginning at a block 901, an automatic or automated topology creation process is carried out by a processing, neural networking, accelerator and memory circuitry such as those configurations illustrated in many of the previous figures. Such circuitry may in exist in whole or in part within any number of remote systems and user devices depending on the underlying configuration and associated topology requirements.

At block 905, user created output is received and analyzed to identify frames of data therein along with a frame pattern for each of the identified frames. Each frame of data identified as being serviceable by either generative AI or support processing nodes to deliver future data content for such frame. Based on user input interaction and/or user's manual creation process observation for each frame, trigger signals, user add-ins, and source data (which the user employs to create their content for a given frame) along with associated path and access information is collected at a block 905. At a block 907, cross frame influence (e.g., inner and inter frame influence) is identified if high correlations of content within two or more different frames exist. For each frame, at a block 909, a selection from various pre-configured and pre-trained AI nodes and support processing nodes is made in an attempt to identify a best node to produce the needed frame content. Such selection process may be conducted by accurate selection without a need for testing. It may also be conducted by training or by a combination of candidate possibility identification along with testing to identify a best fit. The employed selection approach being based at least in part on the data type of source input used by the user and the needed frame content data type output.

A decision is made at a block 911 regarding the selection process. If an acceptable AI or support processing node is identified, then the information needed has been collected and topologies for each frame in an overall AI based topology is automatically generated at a block 915 before the process terminates at a block 917. If on the other hand, at the block 911, no acceptable AI or support processing node has been found from the set of available trained AI nodes and set of available pre-coded support processing nodes, either (i) automatic or automated training of a baseline trained or fully untrained) AI node takes place, or (ii) automatic or automated coding of a new or modified support processing node takes place, at a block 913. Once all frames receive either identified node selected from those offered or have a sufficiently performing node prepared at the block 913, the process ends at the block 917.

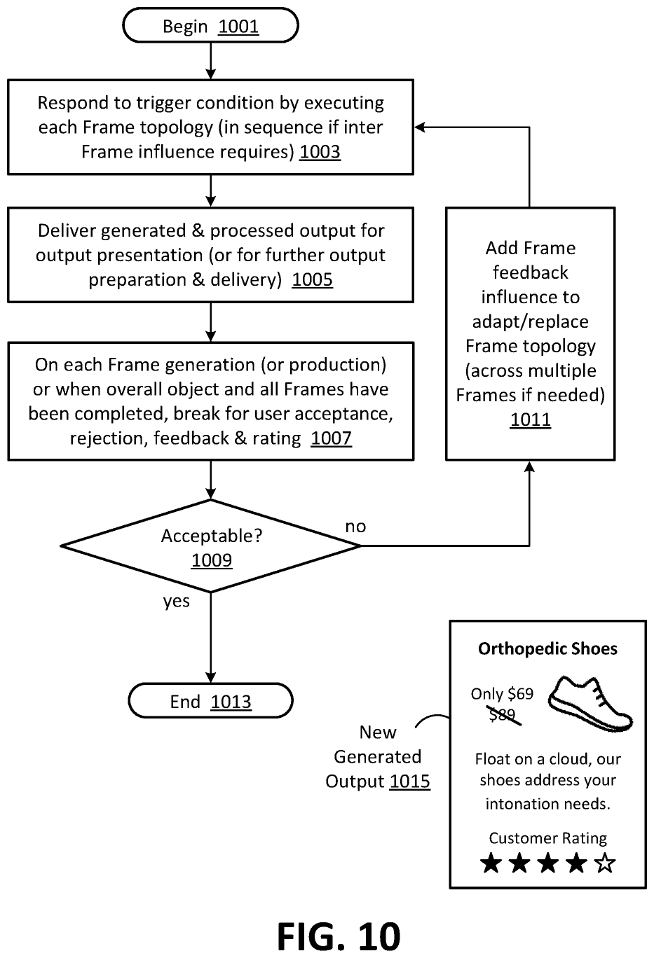

FIG. 10 is another exemplary flow diagram illustrating deployment of a set of topologies auto-generated pursuant to the flow diagram of FIG. 9, wherein such deployment of the set of topologies delivers future generated output data automatically from input data sources with little if any user intervention needed. In particular, the processing, neural networking, accelerator and memory circuitry distributed in whole or in part across pluralities of remote systems and user devices as described in configurations associated with many of the previous figures, the process of generating an output according to an overall AI generative objective according to automatically generated sets of frame topologies begins at a block 1001.

At a block 1003, in responding to a trigger indicating the desire for the overall generation, each frame topology is employed to generate frame content. The plurality of frame topologies being carried out in sequence if cross frame influence is required, in parallel, or in any combination of sequential and parallel processing as the frame topologies and resources require. Some nodes may be carried out locally or remotely in distributed fashion or all at a fixed location to accommodate resource capabilities and any fixed node hosting locations.

At a block 1005, all of the generated and produced content from each topology associated with each frame are prepared for output presentation to a user and/or parts or all delivered to control or communicate with electronic systems such as user devices, hosting services, data storage and so on. Once all frame content has been produced and ready to distribute in combined and/or in unitary delivery formats, at a block 1007, a break is inserted to give a user the opportunity to accept, reject, provide a critique and deliver a rating for the overall output or for any one or more frame outputs specifically.

If a user finds all frames of generated and produced output acceptable, the generation process ends at a block 1013, and the frame outputs in combined or unitary form are distributed. At this point, the user may still be given an opportunity to provide a rating for the overall generated output and to independently rate each frame output individually. Otherwise, if the user finds even one frame output to be unacceptable, at a block 1011, a user may interact to carry out the rejection without more and rerun either the entire generation process or merely to rerun those frame outputs which the user finds unacceptable. In addition, they user may provide a critique and the input data based thereon being used to influence the frame generation of, for example, the unacceptable frame. If this corrects the content generation, the user may indicate a desire to make the influence levied through their critique permanent and, in response, the topology for that frame will be modified to carry that influence into future generation attempts. In this way, through user interaction, the automatically generated topology may be trained to perform in a more acceptable way to please the user. Also, at the block 1011, if numerous reattempts to generate an acceptable frame output occurs, a user may either enter a workspace visualization interface and directly modify or add to a frame's topology to attempt to find a regularly more acceptable generation based thereon. Alternatively, the user may indicate a desire to switch the primary node selection with that of another of what seems to be a second best selection for the user's own evaluation of an alternative AI or support processing nodes performance for a given problematic frame. If that fails, the user may request fine tune training or use automatic or automated support processing code modification or addition. No matter how the user interacts at the block 1011 though, the process branches through the blocks 1003, 1005 and 1007 thereafter to recreate one, many or all of the frame outputs and again reach the block 1009 where the overall frame set outputs can be accepted or not, creating a loop that continues until the user is satisfied and ending the process at the block 1013.

An example of an overall multiple frame generation in this manner is indicated by the output 1015 of a sales brochure. Therein, five frames, each with produced/generated content data shown, were delivered according to five frame based topologies in an automatic or automated way without requiring much if any user involvement. Herein, produced frame content involves support processing node efforts. Generated frame content involved generative AI node efforts. Automatic meaning without user involvement, and automated may involve at least user approval in the process. Some frame topologies are sufficient as is from automatic generation. Other frame topologies that are automatically generated may receive fine tuning, modifications, additions, deletions and so on through a user's manual intervention or in response to a user's critique alone. In these ways, even a non-programmer knowing nothing about generative or discriminative AI can interact to construct AI based topologies with ease and for their own personal needs.

Other aspects of the present invention can be found in configurations of an artificial intelligence infrastructure having circuitry configured to gather at least one user's creation. The circuitry also being configured to automatically generate an overall artificial intelligence based topology based on the at least one user's creation gathered. In another configuration of the artificial intelligence infrastructure, circuitry is configured to gather a creation of a user, the creation serving an overall objective. Such circuitry also configured to automatically identify a plurality of frames from the creation of the user, wherein the plurality of frames being serviced by a corresponding plurality of topologies to accomplish, using artificial intelligence, the overall objective.

Further aspects of the present invention may be found in an artificial intelligence infrastructure having circuitry configured to gather a creation of a user, the creation serving an overall objective, where the circuitry automatically creates a plurality of frame topologies to serve, using artificial intelligence, the overall objective. Yet other aspects can be found in an artificial intelligence infrastructure supporting a user, having first and second circuitry. The first circuitry receives first source data and a user's work product created to service a first purpose, wherein the first source data being utilized by the user in the creation of at least a portion of the user's work product. The second circuitry generates at least one topology to be used in servicing the first purpose using artificial intelligence.

In another configuration of the artificial intelligence infrastructure, yet other aspects may be found. Therein, first circuitry receives first source data information and a human's work product created to service a first purpose, the first source data information being utilized in the creation of at least a portion of the human's work product. Second circuitry is provided which identifies using artificial intelligence at least one portion of the human's work product for future servicing by an artificial intelligence node.

A further embodiment of an artificial intelligence infrastructure illustrates yet other aspects of the present invention with first and second circuitry therein. The first circuitry receives a work product and first source data information used by a human to create the work product to service a first purpose, while the second circuitry configured to identify pattern data associated with at least one portion of the work product, the pattern data being used in future artificial intelligence based servicing of the first purpose.

Within another configuration of an artificial intelligence infrastructure, first and second circuitry operate to illustrate other aspects of the present invention. Specifically, for example, the first circuitry receives a first work product and first source data used by a human to create the work product to service a first purpose. The first circuitry also being configured to identify a plurality of frames based at least in part on the first work product. From the first work product, the second circuitry identifies cross frame influence between at least two of the plurality of frames.

Yet other aspects may be found in an artificial intelligence hosting infrastructure comprising circuitry that generates from a user's work product at least a portion of an artificial intelligence based topology to service a user's overall goal associated with the user's work product, wherein the circuitry also carries out hosting operations of the artificial intelligence based topology to service the user's overall goal.

In another configuration, within an artificial intelligence hosting infrastructure circuitry can be found which generates from a user's work product and underlying source data information at least a portion of an artificial intelligence based topology. The circuitry configured to host operations of the artificial intelligence based topology to carry out artificial intelligence generation in a form that corresponds to that of the user's work product.

Further aspects of the present invention can be found in yet another configuration of an artificial intelligence hosting infrastructure. Therein, circuitry identifies a plurality of elements within a user's overall work product. The plurality of elements are serviced by a corresponding plurality of generative artificial intelligence nodes. The circuitry also hosts artificial intelligence based operations using the plurality of generative artificial intelligence nodes to carry out an overall artificial intelligence based generation in a form that corresponds to that of the user's work product.

Yet other aspects may be found in an artificial intelligence infrastructure configuration with a circuitry that automatically generates from a user's work product at least a portion of an artificial intelligence based topology to service a user's overall goal associated with the user's work product. The circuitry also respond to user interaction relating to operations carried out based on the artificial intelligence based topology by modifying at least one aspect of the artificial intelligence based topology.

Further aspects can be found in circuitry of artificial intelligence infrastructure that automatically generates from a user's work product at least a portion of an artificial intelligence based topology to service a user's overall goal associated with the user's work product. Such circuitry responds to user input by regenerating at least a portion of operations carried out in accordance with the artificial intelligence based topology.

Yet various other aspects of the present can be found in an artificial intelligence infrastructure that supports a user. Therein, circuitry automatically generates, from a work product of the user and from underlying source data information, at least a portion of an artificial intelligence based topology to service an overall goal of the user, the overall goal being serviced by the work product. The circuitry also extracts the underlying source data information by monitoring interactions of the user that the user employed when creating the work product.

In addition, although throughout this specification selected exemplary embodiments have been used to illustrate particular aspects of the present invention, all of these aspects are contemplated as being combinable into a single embodiment or extracted into any subset of such aspects into enumerable other embodiments. Thus, the boundaries of each embodiment regarding particular aspects included therein are merely for illustrating operation of a select group of aspects and are in no way considered to limit the overall breadth of such aspects or the ability of combining them as so desired and as one of ordinary skill in the art can surely contemplate after receiving the teachings herein.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. It may also include neural network circuit elements, accelerators supporting software AI models. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

The term “AI models” refers to a software defined neural network infrastructure that operates on processing circuitry and may use accelerator circuitry to carry out its underlying functionality. Any AI element may also be constructed in whole or in part in hardware via analog and/or digital circuits that play a major part in carrying out AI related functionality. As used herein, the term “AI node” may comprise a purely software AI model or an accelerated AI model. It may also comprise one or more neural network circuits and associated support processing.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description, and can be apportioned and ordered in different ways in other embodiments within the scope of the teachings herein. Alternate boundaries and sequences can be defined so long as certain specified functions and relationships are appropriately performed/present. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block/step boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Although the Internet is taught herein, the Internet may be configured in one of many different manners, may contain many different types of equipment in different configurations, and may be replaced or augmented with any network or communication protocol of any kind.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1-13. (canceled)

14. An artificial intelligence hosting infrastructure comprising:
circuitry configured to identify a plurality of elements within a user's work product, the plurality of elements to be serviced by a corresponding plurality of generative artificial intelligence nodes; and
the circuitry also being configured to host artificial intelligence based operations using the plurality of generative artificial intelligence nodes to carry out an overall artificial intelligence based generation in a form that corresponds to that of the user's work product.

15. The artificial intelligence hosting infrastructure of claim 14, wherein the circuitry is configured to analyze the user's work product to identify recurring patterns for use in the generation of the artificial intelligence-based topology.

16. The artificial intelligence hosting infrastructure of claim 14, wherein the circuitry is configured to store identified patterns as reusable templates that are applicable in a generation of future topologies.

17. The artificial intelligence hosting infrastructure of claim 14, wherein the circuitry is configured to automatically categorize different segments of the user's work product and assign corresponding artificial intelligence nodes optimized for each category.

18. The artificial intelligence hosting infrastructure of claim 17, wherein the circuitry identifies dependencies between different segments to maintain coherence and consistency across the user's work product.

19. The artificial intelligence hosting infrastructure of claim 14, wherein the circuitry is configured to analyze the user's work product to identify common elements for use in the generation of the artificial intelligence-based topology.

20. The artificial intelligence hosting infrastructure of claim 14, wherein the circuitry is configured to store common elements as reusable templates that are applicable in a generation of future topologies.

21. An artificial intelligence infrastructure comprising:
circuitry configured to gather at least one user's creation; and
the circuitry also being configured to automatically generate an overall artificial intelligence based topology according to the at least one user's creation gathered.

22. The artificial intelligence hosting infrastructure of claim 21, wherein the circuitry is configured to analyze the at least one user's creation to identify recurring patterns for use in the generation of the artificial intelligence-based topology.

23. The artificial intelligence hosting infrastructure of claim 21, wherein the circuitry is configured to store identified patterns as reusable templates that are applicable in a generation of future topologies.

24. The artificial intelligence hosting infrastructure of claim 21, wherein the circuitry is configured to automatically categorize different segments of the at least one user's creation and assign corresponding artificial intelligence nodes optimized for each category.

25. The artificial intelligence hosting infrastructure of claim 24, wherein the circuitry identifies dependencies between different segments to maintain coherence and consistency across the at least one user's creation.

26. The artificial intelligence hosting infrastructure of claim 21, wherein the circuitry is configured to analyze the at least one user's creation to identify common elements for use in the generation of the artificial intelligence-based topology.

27. The artificial intelligence hosting infrastructure of claim 21, wherein the circuitry is configured to store common elements as reusable templates that are applicable in a generation of future topologies.

28. An artificial intelligence hosting infrastructure comprising:
circuitry configured to automatically generate from a user's work product at least a portion of an artificial intelligence based topology to service a user's overall goal associated with the user's work product; and
the circuitry configured to host operations of the artificial intelligence based topology to service the user's overall goal.

29. The artificial intelligence hosting infrastructure of claim 28, wherein the circuitry is configured to analyze the user's work product to identify recurring patterns and common elements for use in the generation of the artificial intelligence-based topology.

30. The artificial intelligence hosting infrastructure of claim 28, wherein the circuitry is configured to store identified patterns as reusable templates that are applicable in a generation of future topologies.

31. The artificial intelligence hosting infrastructure of claim 28, wherein the circuitry is configured to automatically categorize different segments of the user's work product and assign corresponding artificial intelligence nodes optimized for each category.

32. The artificial intelligence hosting infrastructure of claim 31, wherein the circuitry identifies dependencies between different segments to maintain coherence and consistency across the user's work product.

33. The artificial intelligence hosting infrastructure of claim 28, wherein the circuitry is configured to store common elements as reusable templates that are applicable in a generation of future topologies.
